(19) United States
(12) Patent Application Publication
(10) Pub. No.: US 2007/0281192 A1
(43) Pub. Date: Dec. 6, 2007

(54) Fuel cell power generation system

(75) Inventor: Norio Sasaki, Tokyo (JP)

Correspondence Address: RABIN & Berdo, PC, 1101 14TH STREET, NW, SUITE 500, WASHINGTON, DC, 20005, US

(73) Assignee: FUJI ELECTRIC HOLDINGS CO., LTD., Kawasaki (JP)

(21) Appl. No.: 11/806,460

(22) Filed: May 31, 2007

(30) Foreign Application Priority Data
Jun. 1, 2006 (JP) JP PA 2006-153067

(51) Int. Cl. H01M 8/06

(52) U.S. Cl. 429/19; 429/34

(57) ABSTRACT

A fuel cell power generation system has a condensing heat exchanger with a decarbonation device for removing carbon dioxide dissolved in condensed water including an inclined plate which has an upper side with an upper surface and a lower side with a lower surface. The inclined plate is made of a porous material, and is configured so that, by circulating air for decarbonation from the lower side toward the upper side of the inclined plate and simultaneously flowing the condensed water down from the upper side toward the lower side of the inclined plate, the condensed water comes into contact with the air for decarbonation on both the upper and lower surfaces of the inclined plate while flowing down along the inclined plate.

### BACKGROUND OF THE INVENTION

1. Field of the Invention

The invention relates to a fuel cell power generation system including a decarbonation device for removing carbon dioxide contained in condensed water.

2. Description of the Related Art

A fuel cell power generation system is a power generation system for converting binding energy between hydrogen and oxygen directly into electrical energy. In such a fuel cell power generation system, a fuel cell main body is used which is configured by stacking plural unit cells having an electrolyte interposed between a fuel electrode and an air electrode, and an electromotive force is obtained by feeding hydrogen in a fuel gas obtained by steam reforming a hydrocarbon based raw fuel, such as a natural gas and oxygen in air, into the fuel electrode and the air electrode, respectively, and utilizing an electrochemical reaction occurred between the fuel and air electrodes.

In order to reform the raw fuel into a fuel gas, a reformer for adding steam to a hydrocarbon based raw fuel such as a natural gas and promoting a reaction between water and the raw fuel by a catalyst is usually used. Accordingly, for the reformer, it is required to supplement water which becomes necessary for reforming a fuel.

In general, ion exchanged water which is obtained by removing impurities from condensed water obtained by condensing a waste gas such as a combustion waste gas discharged from a reformer and a reaction waste gas discharged from a fuel cell main body by an ion exchange type water treatment device or the like is used as water to be used for a reforming reaction.

However, since the combustion waste gas discharged from the reformer has a relatively high carbon dioxide concentration, carbon dioxide is dissolved to an extent of a substantially saturated amount in condensed water which can be recovered from the combustion waste gas. For that reason, in order to reduce a load to the water treatment device, such condensed water is decarbonated prior to performing a purification treatment, thereby removing carbon dioxide dissolved in the condensed water.

As an example of a known decarbonation treatment method for condensed water, a treatment method is performed utilizing a diffusion phenomenon by brining condensed water and air into contact with each other and diffusing carbon dioxide in the condensed water into an air side by means of a diffusion phenomenon.

As a decarbonation device utilizing such a diffusion phenomenon, there has hitherto been used a pipe having a filler, for example, a Raschig ring, filled therein or the like. The decarbonation treatment is carried out by feeding condensed water into an upper part of the pipe and simultaneously feeding air for decarbonation from a lower part of the pipe and bringing the condensed water into contact with the air for decarbonation while gravity dropping the condensed water.

Also, JP-A-8-124590 discloses a decarbonation device including a barrel having a condensed water outlet part in a lower end part thereof, as well as a condensed water inlet part in an upper end part thereof, and plural trays disposed vertically in a multistage manner in this barrel and inclined alternately in a longitudinal direction, with the condensed water being successively dropped from an upper stage side toward a lower stage side. This decarbonation device is characterized in that air flows in the barrel from the condensed water outlet part and is discharged from the condensed water inlet part.

Also, JP-A-2005-103492 discloses a decarbonation device which is characterized by having a configuration such that a spiral plate configuring a spiral flow passage is disposed in a manner that a spiral axis direction is vertically aligned; that a porous filler is disposed in the spiral flow passage; that a gas is introduced into a lower part of the spiral flow passage; and that the gas comes into contact with water while moving within the spiral flow passage.

When the decarbonation treatment of condensed water is insufficient, however, a load to the water treatment device or the like becomes large, an exchange cycle of an ion exchange resin, etc. becomes short, and running costs of the fuel cell power generation system increase. For that reason, in the decarbonation treatment utilizing a diffusion phenomenon, it is necessary to sufficiently secure the contact area and contact time between the air and the condensed water.

However, in the foregoing decarbonation devices of the related art, in order to sufficiently secure the contact area and contact time between air and condensed water, it was necessary to increase the volume by widening the decarbonation device vertically or horizontally. Accordingly, it was difficult to miniaturize the device.

On the other hand, by disposing a filler in a decarbonation device, though it is possible to slightly improve the contact time and contact area between air and condensed water, it was difficult to sufficiently diffuse the condensed water over the whole of the filler, and there was a scattering in the effect for increasing the contact area.

### SUMMARY OF THE INVENTION

Accordingly, an object of the invention is to provide a fuel cell power generation system including a decarbonation device capable of efficiently removing carbon dioxide in condensed water.

In achieving the foregoing object, a fuel cell power generation system according to the invention provides a fuel cell power generation system comprising a fuel cell main body comprised of a stack of plural unit cells, a fuel electrode, an air electrode, and an electrolyte interposed between the fuel electrode and the air electrode; a reformer for reforming a fuel and feeding a reformed gas into the fuel electrode; an air feed device for feeding air into the air electrode; a condensing heat exchanger for recovering condensed water from a waste gas discharged format least one of the fuel cell main body and the reformer; a decarbonation device for removing carbon dioxide dissolved in the condensed water and providing decarbonated condensed water comprised of an inclined plate which has an upper side with an upper surface and a lower side with a lower surface, which is made of a porous material having pores, and which is configured so that, by circulating air for decarbonation from the lower side toward the upper side of the inclined plate and simultaneously flowing the condensed water down from the upper side toward the lower side of the inclined plate, the condensed water comes into contact with the air for decarbonation on both the upper and lower surfaces of the inclined plate while flowing down along the inclined plate in a flow down direction; and a water tank for storing the decarbonated condensed water.

According to the fuel cell power generation system of the invention, since a decarbonation treatment is carried out by using the decarbonation device provided with an inclined plate made of a porous material and configured such that while flowing down condensed water from an upper side toward a lower side of the inclined plate, the condensed water is brought into contact with air for decarbonation countercurrently to a flow-down direction of the condensed water, during a time when the condensed water flows down along the inclined plate, the condensed water is absorbed and kept by the inclined plate, and therefore, it is possible to sufficiently secure the contact time between the air for decarbonation and the condensed water. Also, since the air for decarbonation comes into contact with not only condensed water on an upper surface of the inclined plate but also condensed water which has oozed out onto a lower surface of the inclined plate and air for decarbonation which has passed through pores of the inclined plate and come out from both of the upper and lower surfaces of the inclined plate, the contact area between the condensed water and the air for decarbonation is extremely large. For that reason, since it is possible to sufficiently secure the contact time and contact area between the air for decarbonation and the condensed water in a short movement distance, the decarbonation device can be miniaturized, and the running costs and setting-up spaces of the fuel cell power generation system and so on can be reduced.

Also, in the fuel cell power generation system of the invention, it is preferable that the air for decarbonation is waste air discharged from a discharge side of the air electrode of the fuel cell main body. Since the waste air has a low concentration of carbon dioxide and is substantially equal to usual air, a waste gas can be effectively utilized.

Also, in the fuel cell power generation system of the invention, it is preferable that the inclined plate has defined therein a plurality of parallel longitudinal grooves extending along the flow-down direction of the condensed water on at least the upper surface thereof and parallel to one another. According to this embodiment, the surface area of the inclined plate increases without disturbing the flow of the condensed water, thereby improving the contact area between the air for decarbonation and the condensed water.

Also, in the fuel cell power generation system of the invention, it is preferable that the inclined plate has defined therein a lateral groove which crosses, i.e., extends transverse, to the flow-down direction. Then, the plurality of parallel longitudinal grooves are connected to each other by the lateral groove. According to this embodiment, since the condensed water spreads in a width direction and flows down on the inclined plate, the contact area between the air for decarbonation and the condensed water is improved.

Also, in the fuel cell power generation system of the invention, it is preferable that the inclined plate has defined therethrough a plurality of holes which pass through the upper and lower surfaces of the inclined plate in addition to the pores in the porous material. According to this embodiment, the condensed water flowing down on the upper surface of the inclined plate is easy to go along the through holes and flow down in a side of the lower surface so that it is possible to efficiently bring the air for decarbonation and the condensed water into contact with each other on both of the upper and lower surfaces of the inclined plate.

Also, in the fuel cell power generation system of the invention, it is preferable that the porous material of which the inclined plate is made is selected from among at least one of a porous carbon plate, an expanded metal, an expanded glass, a sponge, a non-woven fabric, and a fabric. Since such a porous material is high in surface area and porosity, the contact area between the air for decarbonation and the condensed water on the both surfaces of the inclined plate is improved.

Also, in the fuel cell power generation system of the invention, it is preferable that the decarbonation device has defined therein a first blowout port for blowing the air for decarbonation onto the upper surface of the inclined plate to circulate the air from the lower side toward the upper side of the inclined plate, and a second blowout port for blowing the air for decarbonation onto the lower surface of the inclined plate. According to this embodiment, since the air for decarbonation can be sub-stantially uniformly blown onto the whole of the upper and lower surfaces of the inclined plate, it is possible to efficiently bring the air for decarbonation and the condensed water into contact with each other on both of the upper and lower surfaces of the inclined plate.

Also, in the fuel cell power generation system of the invention, it is preferable that in the decarbonation device, the inclined plate is a plurality of inclined plates, and each inclined plate of the plurality of inclined plates has an inclination direction and each inclined plate of the plurality of inclined plates has the same inclination direction. According to this embodiment, a large amount of condensed water can be decarbonated at once.

Also, in the fuel cell power generation system of the invention, it is preferable that in the decarbonation device, the inclined plate is a plurality of inclined plates, and each inclined plate of the plurality of inclined plates has an inclination direction and alternate ones of the plurality of inclined plates extend in an inclination direction which is opposite to that of the inclination direction of a preceding inclined plate. According to this embodiment, the contact time between the condensed water and the air for decarbonation becomes long so that the decarbonation treatment can be more effectively carried out.

Also, in the fuel cell power generation system of the invention, it is preferable that in the decarbonation device, the inclined plate has a width direction and a plurality of blowout nozzles disposed in one of a slit state or at prescribed intervals, and the air for decarbonation is blown out along the width direction of the inclined plate from the plurality of blowout nozzles. According to this embodiment, since the air for decarbonation can be substantially uniformly distributed on the inclined plate, the condensed water efficiently comes into contact with the air for decarbonation so that the decarbonation treatment can be efficiently carried out.

Also, in the fuel cell power generation system of the invention, it is preferable that in the decarbonation device, the inclined plate has a width direction and a plurality of drain nozzles disposed in one of a slit state or at prescribed intervals, and the condensed water flows down along the width direction of the inclined plate from the plurality of drain nozzles. According to this embodiment, since the condensed water can be substantially uniformly distributed on the inclined plate, the contact area between the condensed water and the air for decarbonation increases so that the decarbonation treatment can be efficiently carried out.

According to the fuel cell power generation system of the invention, since the contact time and contact area between the air for decarbonation and the condensed water can be sufficiently secured, the decarbonation device can be miniaturized, and the running costs and setting-up spaces of the fuel cell power generation system and so on can be reduced.

### BRIEF DESCRIPTION OF THE DRAWINGS

FIG. 1 is an outline configuration view of a fuel cell power generation system of the invention.

FIG. 2 is a view to show a first embodiment of a decarbonation device used in a fuel cell power generation system of the invention.

FIG. 3 is a view to show another example of a decarbonation device used in a fuel cell power generation system of the invention.

FIG. 4 is a view to show one example of an inclined plate used in a decarbonation device.

FIG. 5 is a view to show another example of an inclined plate used in a carbonation device.

FIG. 6 is a view to show a second embodiment of a decarbonation device used in a fuel cell power generation system of the invention.

FIG. 7 is a view to show a third embodiment of a decarbonation device used in a fuel cell power generation system of the invention:

FIG. 8 is a view to show a fourth embodiment of a decarbonation device used in a fuel cell power generation system of the invention.

### DESCRIPTION OF THE PREFERRED EMBODIMENTS

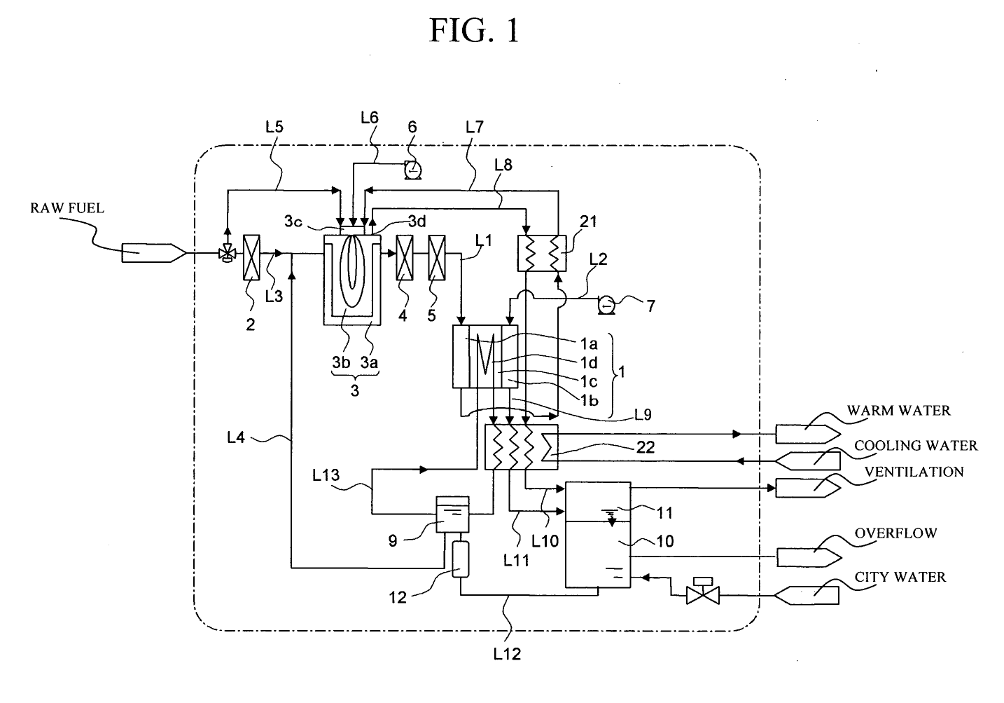

Embodiments of the fuel cell power generation system of the invention are hereunder described with reference to the accompanying drawings. FIG. 1 is an outline configuration view of a fuel cell power generation system of the invention.

The fuel cell power generation system of the invention is mainly configured of a fuel cell main body 1, which is configured to include a fuel electrode 1a and an air electrode 1b interposing an electrolyte 1c there between, and a cooling system 1d having a cooling pipe disposed every time of superimposing plural unit cells composed of them; a reformer 3 for feeding a reformed gas composed mainly of hydrogen obtained by reforming a fuel into the fuel electrode 1a; an air feed device 7 for feeding air into the air electrode 1b through the air feed line L2; a condensing heat exchanger 22 for recovering condensed water from a waste gas discharged from the fuel cell main body 1 and/or the reformer 3; a decarbonation device 11 for removing carbon dioxide dissolved in the recovered condensed water; and a water tank 10 for storing the condensed water having been decarbonated in the decarbonation device 11.

The reformer 3 is configured as a reforming catalyst part 3a and a burner part 3b.

A throwing side of a reforming raw material of the reforming catalyst part 3a is connected to a desulfurizer 2 via a raw material feed line L3. Also, the raw material feed line L3 is branched and connected to a purified water storage tank 9 via a purified water feed line L4. A recovery side of a reformed gas is connected to the fuel electrode 1 a via a refined gas feed line L1 on which a transformer 4 and a CO remover 5 are disposed. On the other hand, a fuel inlet 3c of the burner part 3b is connected to a start-up fuel feed line L5 branched from the raw material feed line L3, a combustion air feed line L6 connected to a combustion air blower 6, and an off-gas feed line L7 on which a fuel pre-heater 21 connected to an off-gas discharge side of the fuel electrode 1a is disposed. Also, a combustion waste gas outlet 3d of the burner part 3b is connected to the condensing heat exchanger 22 via a combustion waste gas line L8 on which the fuel pre-heater 21 is disposed.

In the reformer 3, air for combustion fed from the combustion air feed line L6 and a raw fuel fed from the start-up fuel feed line L5 and/or an off-gas fed from the off-gas feed line L7 are combusted in the burner part 3b to heat the reforming catalyst part 3a. In the reforming catalyst part 3a, a raw fuel having been desulfurized in the desulfurizer 2 is fed from the raw material feed line L3 and purified water is fed from the purified water feed line L4, and are subjected to a reforming reaction to form a hydrogen-rich reformed gas. After the concentration of carbon monoxide of the reformed gas formed in the reformer 3 has been reduced in the transformer 4 and the CO remover 5, the reformed gas is fed into the fuel electrode la from the reformed gas feed line L1.

A waste air gas discharge side of the air electrode 1b of the fuel cell main body 1 is connected to the condensing heat exchanger 22 via an air discharge line L9.

An upper side of the condensing heat exchanger 22 is connected to the combustion waste gas line L8 and the air discharge line L9. Also, a lower side of the condensing heat exchanger 22 is connected to a feed line L11 of air for decarbonation for feeding a waste air gas after the condensation treatment in the condensing heat exchanger 22 into the decarbonation device 11 and a condensed water recovery line L10 for feeding condensed water condensed and recovered from a waste gas such as a combustion waster gas and waste air into the decarbonation device 11.

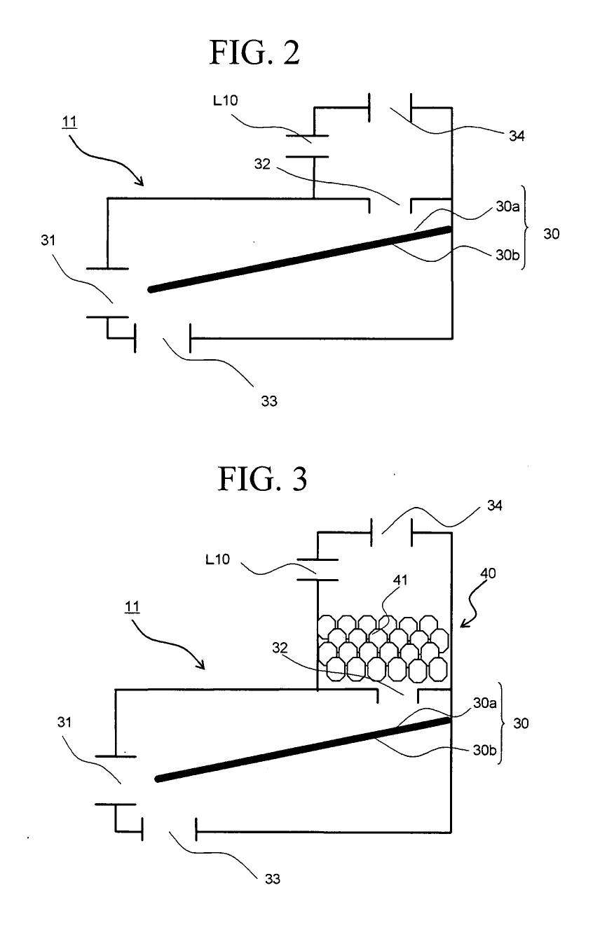

In this embodiment, a decarbonation device as illustrated in FIG. 2 is used as the decarbonation device 11. That is, in this decarbonation device 11, a drain port 32 which is an introduction port for condensed water is connected to the condensed water recovery line L10 and an exhaust port 34 for discharging air for decarbonation having carbon dioxide in condensed water taken therein and a combustion waste gas are provided in an upper part thereof; a blowout port 3, which is an air inlet for decarbonation is connected to the feed line L11 of air for decarbonation is provided in a lower part thereof; a decarbonated condensed water recovery port 33 connected to the water tank 10 is provided in a bottom part thereof; and the inclined plate 30 made of a porous material is disposed in the inside thereof.

The condensed water fed from the drain port 32 toward the upper surface 30a of the inclined plate 30 comes into contact with air for carbonation fed from the blowout port 31 and is decarbonated by means of a diffusion phenomenon. The condensed water having been decarbonated is fed into the water tank 10 from the decarbonated condensed water recovery port 33 provided in the lower end part. Also, the air for decarbonation fed from the blowout port 31 takes in carbon dioxide in the condensed water and is discharged from the exhaust port 34.

In the invention, since the inclined plate 30 is made of a porous material, the condensed water flowing down in the side of the upper surface 30a is absorbed and kept by the inclined plate 30 and oozes out into the side of the lower surface 30b. For that reason, it is possible to sufficiently secure the contact time between the air for decarbonation and the condensed water. Also, since the air for decarbonation comes into contact with not only condensed water on the upper surface 30a of the inclined plate 30 but also condensed water which has oozed out onto the lower surface 30b of the inclined plate 30 and decarbonated air which has passed through pores of the inclined plate and come out from both of the upper and lower surfaces of the inclined plate 30, the contact area between the condensed water and the air for decarbonation is extremely large. Accordingly, it is possible to sufficiently secure the contact time and contact area between the air for decarbonation and the condensed water in a short movement distance, the decarbonation efficiency is high, and the decarbonation device can be miniaturized. In addition, a load to a water treatment device as described later or the like can be reduced and it is possible to devise to reduce the running costs and setting-up spaces of the fuel cell power generation system. Incidentally, as was used likewise in the decarbonation devices of the related art, in the invention, a deaeration column 40 filled with a Raschig ring 41, such as SUS, may be disposed in an upper portion of the drain port 32, whereby the condensed water can be subjected to a pre-deaeration treatment by the deaeration column 40, as illustrated in FIG. 3. However, according to the decarbonation device of the invention, since the decarbonation efficiency is high as described previously, it is preferable that the deaeration column 40 is not particularly provided from the viewpoints of miniaturizing the fuel cell power generation system, improving the maintenance and reducing the device costs.

In the invention, it is preferable that a blowout nozzle in a slit state disposed along a width direction of the inclined plate 30 or plural blowout nozzles disposed at prescribed intervals along a width direction of the inclined plate 30 are installed in the blowout port 31. According to this, since the air for decarbonation can be substantially uniformly blown onto the inclined plate 30, the condensed water can be efficiently brought into contact with the air for decarbonation so that a decarbonation performance is improved.

Also, it is preferable that a drain nozzle in a slit state disposed along a width direction of the inclined plate 30 or a plurality of drain nozzles disposed at prescribed intervals along a width direction of the inclined plate 30 are installed in the drain port 32. According to this, since the condensed water can be substantially uniformly distributed onto the inclined plate 30, the contact area between the condensed water and the air for decarbonation increases so that a decarbonation performance is improved.

Also, it is preferable that the inclined plate 30 is made of at least one member selected from a porous carbon plate, an expanded metal, an expanded glass, a sponge, a non-woven fabric and a fabric. Of these, a porous carbon plate is especially preferable because it is high in strength and excellent in workability, has widely distributed fine pores ranging from fine pores having a small pore size of several μm to fine pores having a large pore size of several hundreds μm, and a gas-liquid interface is easily formed.

Examples of the porous carbon plate include porous carbon plates used for an electrode substrate of a fuel cell as disclosed in JP-A-11-263681 and JP-A-11-224678. Examples of the expanded metal include “Stainless Steel Fiber NF-15 ML1” (a trade name, manufactured by Nippon Seisen Co., Ltd.). Examples of the expanded glass include “Q-Foam” (a trade name, manufactured by Toyo Glass Co., Ltd.). Examples of the non-woven fabric include “Carbel CFP” (a trade name, manufactured by Japan Gore-Tex Inc.). Examples of the woven fabric include “Carbel CL” (a trade name, manufactured by Japan Gore-Tex Inc.).

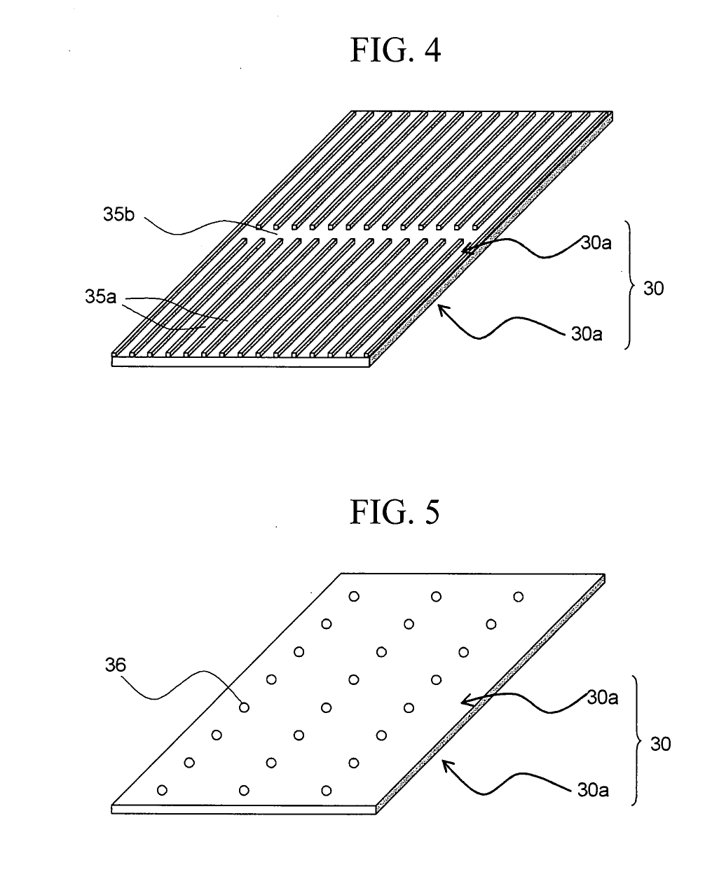

Also, it is preferable that parallel longitudinal grooves 35a are provided along the flow-down direction on at least the upper surface 30a of the inclined plate 30, as illustrated in FIG. 4. It is preferable that the longitudinal grooves 35a are connected to each other by a lateral groove 35b crossing to the flow-down direction. By providing the longitudinal grooves 35a, the contact area between the air for decarbonation and the condensed water increases since the condensed water flows along the bottom surfaces and wall surfaces of the grooves. Also, by connecting the longitudinal grooves 35a to each other by the lateral groove 35b, the contact area between the air for decarbonation and the condensed water increases since the condensed water is easily spread in a width direction of the inclined plate 30.

Also, it is preferable that the inclined plate 30 further has through holes 36 passing through the upper and lower surfaces of the inclined plate 30 as formed by means of mechanical working or the like in addition to the pores in the porous material, as illustrated in FIG. 5. By providing the through holes 36, the condensed water flowing down on the upper surface 30a of the inclined plate 30 also flows into a side of the lower surface 30b of the inclined plate 30 through the through holes 36. For that reason, the condensed water comes into contact with the air for decarbonation on both of the upper and lower surfaces of the inclined plate 30 so that the contact area between the condensed water and the air for decarbonation increases.

Pore size for the through holes 36 preferably ranges from 0.5 to 2.0 mm, and, more preferably, from 0.5 to 1.0 mm. Also, the through holes 36 are preferably disposed at intervals ranging from 1.0 to 10.0 mm and, more preferably, are disposed at intervals ranging from 1.0 to 2.0 mm.

The condensed water having been decarbonated in the decarbonation device 11 is introduced into the water tank 10 and fed into a water treatment device 12 from a decarbonated condensed water recovery line L12. The condensed water (purified water), having been purified in the water treatment device 12, is fed into the purified water storage tank 9; fed from a cooling water line L13 into the cooling system 1d of the fuel cell main body 1 and the condensing heat exchanger 22; and circulated and utilized as cooling water, or fed into the reforming catalyst part 3a of the reformer 3 from the purified water feed line L4 and utilized for a reforming reaction of the raw fuel.

In light of the above, the fuel cell power generation system of the invention permits the decarbonation device to be miniaturized, and the running costs and setting-up spaces of the fuel cell power generation system and so on to be reduced since the contact time and contact area between the air for decarbonation and the condensed water can be sufficiently secured.

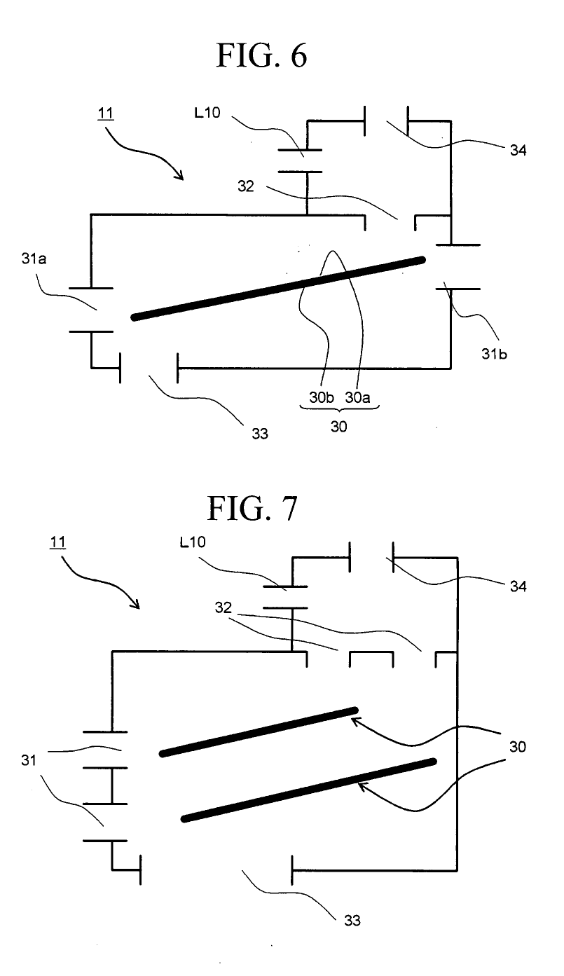

FIG. 6 shows a second embodiment of the decarbonation device 11 which can be used in the fuel cell power generation system of the invention.

A point of difference from the decarbonation device 11 of the first embodiment is that a first blowout port 31a, for blowing the air for decarbonation onto the upper surface 30a of the inclined plate 30 to circulate it from the lower side toward the upper side of the inclined plate 30, and a second blowout port 31b, for blowing the air for decarbonation onto the lower surface 30b of the inclined plate 30 to circulate it from the upper side toward the lower side of the inclined plate 30, are disposed. Incidentally, the second blowout port 31b is disposed so as to blow the air for decarbonation onto the lower surface 30b of the inclined plate 30 to circulate it from the lower side toward the upper side of the inclined plate 30.

According to this embodiment, since the air for decarbonation can be substantially uniformly blown on the both of the upper and lower surfaces of the inclined plate 30, the condensed water which has been absorbed by the inclined plate 30 and oozed out into a side of the lower surface 30b of the inclined plate 30 can be effectively decarbonated. Also, since the air for decarbonation is blown from the lower surface 30b of the inclined plate 30 due to pores of the porous material of the inclined plate, the contact area between the condensed water and the air for decarbonation becomes large so that the decarbonation efficiency is improved.

FIG. 7 shows a third embodiment of the decarbonation device 11 which can be used in the fuel cell power generation system of the invention.

A point of difference from the decarbonation device 11 of the first embodiment is that the inclined plates 30, having the same inclination direction, are disposed vertically in a multistage manner. According to this, a large amount of condensed water can be decarbonated at once so that the decarbonation efficiency is improved.

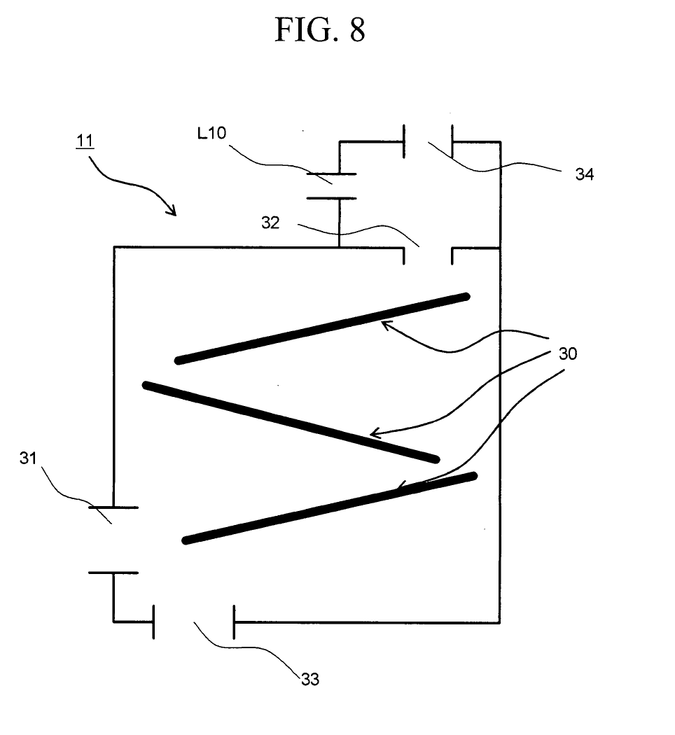

FIG. 8 shows a fourth embodiment of the decarbonation device 11 which can be used in the fuel cell power generation system of the invention.

A point of difference from the decarbonation device 11 of the first embodiment is that the inclined plates 30, inclined alternately in an opposite direction to each other, are disposed vertically in a multistage manner. According to this, the contact time between the condensed water and the air for decarbonation becomes long so that the decarbonation treatment can be more effectively carried out.

While the invention has been described in conjunction with embodiments and variations thereof, one of ordinary skill, after reviewing the foregoing specification, will be able to effect various changes, substitutions of equivalents and other alterations without departing from the broad concepts disclosed herein. It is therefore intended that Letters Patent granted hereon be limited only by the definition contained in the appended claims and equivalents thereof.

What is claimed is:

1. A fuel cell power generation system, comprising:
a fuel cell main body comprised of a stack of plural unit cells, a fuel electrode, an air electrode, and an electrolyte interposed between the fuel electrode and the air electrode;
a reformer for reforming a fuel and feeding a reformed gas into the fuel electrode;
an air feed device for feeding air into the air electrode;
a condensing heat exchanger for recovering condensed water from a waste gas discharged format least one of the fuel cell main body and the reformer;
a decarbonation device for removing carbon dioxide dissolved in the condensed water and providing decarbonated condensed water comprised of an inclined plate which has an upper side with an upper surface and a lower side with a lower surface, which is made of a porous material having pores, and which is configured so that, by circulating air for decarbonation from the lower side toward the upper side of the inclined plate and simultaneously flowing the condensed water down from the upper side toward the lower side of the inclined plate, the condensed water comes into contact with the air for decarbonation on both the upper and lower surfaces of the inclined plate while flowing down along the inclined plate in a flow down direction; and
a water tank for storing the decarbonated condensed water.

2. The fuel cell power generation system according to claim 1, wherein the air electrode has a discharge side for discharging waste air and wherein the air for decarbonation is the waste air discharged from the discharge side of the air electrode.

3. The fuel cell power generation system according to claim 1, wherein the inclined plate has defined therein a plurality of parallel longitudinal grooves extending along the flow-down direction of the condensed water on at least the upper surface thereof and parallel to one another.

4. The fuel cell power generation system according to claim 3, wherein the inclined plate has defined therein a lateral groove extending transverse to the flow-down direction and wherein the plurality of parallel longitudinal grooves are connected to each other by the lateral groove.

5. The fuel cell power generation system according to claim 1, wherein inclined plate has defined therethrough a plurality of holes which pass through the upper and lower surfaces of the inclined plate.

6. The fuel cell power generation system according to claim 1, wherein the porous material of which the inclined plate is made is selected from among at least one of a porous carbon plate, an expanded metal, an expanded glass, a sponge, a non-woven fabric, and a fabric.

7. The fuel cell power generation system according to claim 1, wherein the decarbonation device has defined therein a first blowout port for blowing the air for decarbonation onto the upper surface of the inclined plate to circulate the air from the lower side toward the upper side of the inclined plate, and a second blowout port for blowing the air for decarbonation onto the lower surface of the inclined plate.

8. The fuel cell power generation system according to claim 1, wherein the inclined plate is a plurality of inclined plates, and wherein each inclined plate of the plurality of inclined plates has an inclination direction and each inclined plate of the plurality of inclined plates has the same inclination direction.

9. The fuel cell power generation system according to claim 1, wherein the inclined plate is a plurality of inclined plates, and wherein each inclined plate of the plurality of inclined plates has an inclination direction and alternate ones of the plurality of inclined plates extend in an inclination direction which is opposite to that of the inclination direction of a preceding inclined plate.

10. The fuel cell power generation system according to claim 1, wherein the inclined plate has a width direction and a plurality of blowout nozzles disposed in one of a slit state or at prescribed intervals, and wherein the air for decarbonation is blown out along the width direction of the inclined plate from the plurality of blowout nozzles.

11. The fuel cell power generation system according to claim 1, wherein the inclined plate has a width direction and a plurality of drain nozzles disposed in one of a slit state or at prescribed intervals, and wherein the condensed water flows down along the width direction of the inclined plate from the plurality of drain nozzles.

12. The fuel cell power generation system according to claim 1, wherein the air electrode has a discharge side for discharging waste air and wherein the air for decarbonation is the waste air discharged from the discharge side of the air electrode, and wherein the inclined plate has defined therein a plurality of parallel longitudinal grooves extending along the flow-down direction of the condensed water on at least the upper surface thereof and parallel to one another.

13. The fuel cell power generation system according to claim 12, wherein the inclined plate has defined therein a lateral groove extending transverse to the flow-down direction and wherein the plurality of parallel longitudinal grooves are connected to each other by the lateral groove.

14. The fuel cell power generation system according to claim 1, wherein the air electrode has a discharge side for discharging waste air and wherein the air for decarbonation is the waste air discharged from the discharge side of the air electrode, wherein the inclined plate has defined therein a plurality of parallel longitudinal grooves extending along the flow-down direction of the condensed water on at least the upper surface thereof and parallel to one another, wherein the inclined plate has defined therein a lateral groove extending transverse to the flow-down direction and wherein the plurality of parallel longitudinal grooves are connected to each other by the lateral groove, and wherein inclined plate has defined therethrough a plurality of holes which pass through the upper and lower surfaces of the inclined plate.

15. The fuel cell power generation system according to claim 1, wherein the air electrode has a discharge side for discharging waste air and wherein the air for decarbonation is the waste air discharged from the discharge side of the air electrode, wherein the inclined plate has defined therein a plurality of parallel longitudinal grooves extending along the flow-down direction of the condensed water on at least the upper surface thereof and parallel to one another, wherein the inclined plate has defined therein a lateral groove extending transverse to the flow-down direction and wherein the plurality of parallel longitudinal grooves are connected to each other by the lateral groove, wherein inclined plate has defined therethrough a plurality of holes which pass through the upper and lower surfaces of the inclined plate, and wherein the porous material of which the inclined plate is made is selected from among at least one of a porous carbon plate, an expanded metal, an expanded glass, a sponge, a non-woven fabric, and a fabric.

16. The fuel cell power generation system according to claim 1, wherein the air electrode has a discharge side for discharging waste air and wherein the air for decarbonation is the waste air discharged from the discharge side of the air electrode, wherein the inclined plate has defined therein a plurality of parallel longitudinal grooves extending along the flow-down direction of the condensed water on at least the upper surface thereof and parallel to one another, wherein the inclined plate has defined therein a lateral groove extending transverse to the flow-down direction and wherein the plurality of parallel longitudinal grooves are connected to each other by the lateral groove, and wherein the decarbonation device has defined therein a first blowout port for blowing the air for decarbonation onto the upper surface of the inclined plate to circulate the air from the lower side toward the upper side of the inclined plate, and a second blowout port for blowing the air for decarbonation onto the lower surface of the inclined plate.

17. The fuel cell power generation system according to claim 1, wherein the air electrode has a discharge side for discharging waste air and wherein the air for decarbonation is the waste air discharged from the discharge side of the air electrode, wherein the inclined plate has defined therein a plurality of parallel longitudinal grooves extending along the flow-down direction of the condensed water on at least the upper surface thereof and parallel to one another, wherein the inclined plate has defined therein a lateral groove extending transverse to the flow-down direction and wherein the plurality of parallel longitudinal grooves are connected to each other by the lateral groove, wherein inclined plate has defined therethrough a plurality of holes which pass through the upper and lower surfaces of the inclined plate, wherein the decarbonation device has defined therein a first blowout port for blowing the air for decarbonation onto the upper surface of the inclined plate to circulate the air from the lower side toward the upper side of the inclined plate, and a second blowout port for blowing the air for decarbonation onto the lower surface of the inclined plate, and wherein the inclined plate is a plurality of inclined plates, and wherein each inclined plate of the plurality of inclined plates has an inclination direction and each inclined plate of the plurality of inclined plates has the same inclination direction.

18. The fuel cell power generation system according to claim 1, wherein the air electrode has a discharge side for discharging waste air and wherein the air for decarbonation is the waste air discharged from the discharge side of the air electrode, wherein the inclined plate has defined therein a plurality of parallel longitudinal grooves extending along the flow-down direction of the condensed water on at least the upper surface thereof and parallel to one another, wherein the inclined plate has defined therein a lateral groove extending transverse to the flow-down direction and wherein the plurality of parallel longitudinal grooves are connected to each other by the lateral groove, wherein inclined plate has defined therethrough a plurality of holes which pass through the upper and lower surfaces of the inclined plate, wherein the decarbonation device has defined therein a first blowout port for blowing the air for decarbonation onto the upper surface of the inclined plate to circulate the air from the lower side toward the upper side of the inclined plate, and a second blowout port for blowing the air for decarbonation onto the lower surface of the inclined plate, and wherein the inclined plate is a plurality of inclined plates, and wherein each inclined plate of the plurality of inclined plates has an inclination direction and alternate ones of the plurality of inclined plates extend in an inclination direction which is opposite to that of the inclination direction of a preceding inclined plate.

19. The fuel cell power generation system according to claim 1, wherein the air electrode has a discharge side for discharging waste air and wherein the air for decarbonation is the waste air discharged from the discharge side of the air electrode, wherein the inclined plate has defined therein a plurality of parallel longitudinal grooves extending along the flow-down direction of the condensed water on at least the upper surface thereof and parallel to one another, wherein the inclined plate has defined therein a lateral groove extending transverse to the flow-down direction and wherein the plurality of parallel longitudinal grooves are connected to each other by the lateral groove, wherein inclined plate has defined therethrough a plurality of holes which pass through the upper and lower surfaces of the inclined plate, wherein the decarbonation device has defined therein a first blowout port for blowing the air for decarbonation onto the upper surface of the inclined plate to circulate the air from the lower side toward the upper side of the inclined plate, and a second blowout port for blowing the air for decarbonation onto the lower surface of the inclined plate, wherein the inclined plate is a plurality of inclined plates, and wherein each inclined plate of the plurality of inclined plates has an inclination direction and one of (a) each inclined plate of the plurality of inclined plates has the same inclination direction and (b) alternate ones of the plurality of inclined plates extend in an inclination direction which is opposite to that of the inclination direction of a preceding inclined plate, and wherein the inclined plate has a width direction and a plurality of blowout nozzles disposed in one of a slit state or at prescribed intervals, and wherein the air for decarbonation is blown out along the width direction of the inclined plate from the plurality of blowout nozzles.

20. The fuel cell power generation system according to claim 1, wherein the air electrode has a discharge side for discharging waste air and wherein the air for decarbonation is the waste air discharged from the discharge side of the air electrode, wherein the inclined plate has defined therein a plurality of parallel longitudinal grooves extending along the flow-down direction of the condensed water on at least the upper surface thereof and parallel to one another, wherein the inclined plate has defined therein a lateral groove extending transverse to the flow-down direction and wherein the plurality of parallel longitudinal grooves are connected to each other by the lateral groove, wherein inclined plate has defined therethrough a plurality of holes which pass through the upper and lower surfaces of the inclined plate, wherein the decarbonation device has defined therein a first blowout port for blowing the air for decarbonation onto the upper surface of the inclined plate to circulate the air from the lower side toward the upper side of the inclined plate, and a second blowout port for blowing the air for decarbonation onto the lower surface of the inclined plate, wherein the inclined plate is a plurality of inclined plates, wherein each inclined plate of the plurality of inclined plates has an inclination direction and one of (a) each inclined plate of the plurality of inclined plates has the same inclination direction and (b) alternate ones of the plurality of inclined plates extend in an inclination direction which is opposite to that of the inclination direction of a preceding inclined plate, wherein the inclined plate has a width direction and a plurality of blowout nozzles disposed in one of a slit state or at prescribed intervals, and wherein the air for decarbonation is blown out along the width direction of the inclined plate from the plurality of blowout nozzles, and wherein the inclined plate has a width direction and a plurality of drain nozzles disposed in one of a slit state or at prescribed intervals, and wherein the condensed water flows down along the width direction of the inclined plate from the plurality of drain nozzles.
